(19) United States
(12) Patent Application Publication
(10) Pub. No.: US 2024/0151564 A1
(43) Pub. Date: May 9, 2024

(54) CARBON DIOXIDE MULTIPHASE FLOW MEASUREMENT BASED ON DIELECTRIC PERMITTIVITY

(71) Applicant: Schlumberger Technology Corporation, Sugar Land, TX (US)

(72) Inventor: Cheng-Gang Xie, Singapore (SG)

(21) Appl. No.: 18/063,158

(22) Filed: Dec. 8, 2022

Related U.S. Application Data
(60) Provisional application No. 63/382,753, filed on Nov. 8, 2022.

(51) Int. Cl. G01F 1/36; G01F 1/20; G01F 1/74

(52) U.S. Cl. CPC G01F 1/363; G01F 1/206; G01F 1/74; G01F 1/44

(57) ABSTRACT

Methods and apparatus for determining mass flow rate of a CO₂ rich stream using dielectric permittivity are described. A method herein measures a dielectric permittivity of a CO₂ rich stream; determines a density of the CO₂ rich stream from the measured dielectric permittivity; determines a viscosity of the CO₂ rich stream from the measured dielectric permittivity; measures a pressure drop of the CO₂ rich stream flowing through a flow restriction; and determines mass flow rate of the CO₂ rich stream using the measured pressure drop, the determined density, and the determined viscosity.

### FIELD

This patent application relates to apparatus and methods for measuring mass flow rate of a CO₂ rich stream. Specifically, apparatus and methods for measuring mass flow rate of a multi-phase CO₂ rich stream using dielectric permittivity are described.

### BACKGROUND

Carbon capture, utilization, storage (CCUS), or Carbon capture, sequestration (CCS) applications at surface or subsea rely on accurate measurements of CO₂ mass flow rate to manage reporting, inventory, distribution, and other aspects of such operations. Accurate measurements are desired for process control, leak detection, and verification of CO₂ quantities for regulatory purposes. In one instance, mass flow rate error of no more than 2.5% may be required.

Currently, ultrasonic meters, turbine meters and Coriolis meters have been used and/or proposed for mass flow measurement of CO₂ rich streams. The ultrasonic meters and turbine meters are used to measure volumetric flow in a dense liquid or supercritical phase, and pressure-temperature-volume (PVT) or equation-of-state (EoS) models or gamma densitometers are used to determine or measure flow density in order to calculate mass flow rate. Such methods are complicated by the complexity in the changing phase behavior of CO₂ rich streams with different impurities and in the difficulty in controlling fluid flow phase which can cause multi-phase conditions to arise near e.g. CO₂ critical point pressure (P_{c}=73.77 bar) and temperature (T_{c}=30.98 degC.).

Coriolis flow meters have been tested, and have been determined, in one case, to have 5% error for two-phase flow of a CO₂ rich stream. Use of machine learning techniques to classify flow patterns, along with individual phase models have been shown to improve the result obtained from Coriolis flow meters to an error rate of 1.5-2%, but Coriolis devices for large pipes are relatively bulky and expensive.

Improved methods and apparatus for accurate measurement of mass flow rate of a CO₂ rich stream are needed.

### SUMMARY

Embodiments described herein provide a method, comprising measuring a dielectric permittivity of a CO₂ rich stream; determining a density of the CO₂ rich stream from the measured dielectric permittivity; determining a viscosity of the CO₂ rich stream from the measured dielectric permittivity; measuring a pressure drop of the CO₂ rich stream flowing through a flow restriction; and determining mass flow rate of the CO₂ rich stream using the measured pressure drop, the determined density, and the determined viscosity.

### BRIEF DESCRIPTION OF THE DRAWINGS

FIGS. 1A-1D are schematic views of flow measurement devices that can be used to practice the methods described herein to determine mass flow of a CO₂ rich stream.

### DETAILED DESCRIPTION

Mass flow rate measurement with relative error less than about 2.5% is needed for many CO₂ flow CCUS or CCS applications at topside or subsea. Such error in flow rates can be realized by using a flow restriction (such as an orifice plate, a flow nozzle, or a Venturi device) to detect a pressure drop across the flow restriction of a flowing CO₂-rich stream, and co-locating with the flow restriction a bulk fluid dielectric permittivity sensor. Flow rates from pressure drop measured across a flow restriction are available using known relations. For example, using a Venturi flow restriction, mass flow rate is given by the following known equation:

Qₘ=\sqrt{2/(1−β⁴)}C_{d}(Re)A_{T}\sqrt{ρΔP} (1)

where Qₘ is the mass flow rate, C_{d} is the discharge coefficient, which is a function of Reynolds Number Re, A_{T} is the Venturi throat cross-sectional area, and β is the ratio of throat diameter to inlet diameter. Density of the fluid is ρ and pressure drop across the Venturi flow restriction is ΔP. Reynolds Number, at a Venturi flow restriction, is related to mass flow rate by the following equation:

$$Re = \frac{V D}{μ / ρ} = \frac{V D}{η} = \frac{4 {Q}_{m}}{π D μ} \qquad ( 2 )$$

where D is the Venturi throat inner diameter, μ is the dynamic viscosity, V is the flow velocity at the Venturi throat section, η is the kinematic viscosity. Discharge coefficients are available as tables or equations incorporating Reynolds Number. Thus, if flow pressure drop and fluid bulk density are known, an iterative process can be followed to calculate the Reynolds Number and discharge coefficient and to converge upon the mass flow rate of a stream.

Fluid bulk density of a CO₂ rich stream can be ascertained from measuring bulk (relative) dielectric permittivity or dielectric constant εᵣ of the CO₂ rich stream. Research shows that, for CO₂, bulk fluid dielectric permittivity of CO₂ can be fitted to a quadratic function of bulk density to high precision, largely independent of flow pressure and temperature, as follows:

εᵣ=1+Aρ+Bρ² (3)

where A=5.099×10⁻⁴ m³/kg and B=1.189×10⁻⁷ m⁶/kg². Equation 3 is shown to be valid at pressures of 1 bar to 300 bar and temperatures of 0° C. to 80° C., covering the pressure and temperature operating range of the CCUS applications. The critical point CO₂ density is ρ_{c}=464 kg/m³ and the corresponding dielectric permittivity is ε_{r,c}=1.262. Research also shows that, unlike the dynamic viscosity (μ), the kinematic viscosity of CO₂ has a similarly good correlation with the bulk fluid dielectric permittivity, largely independent of flow pressure and temperature, as follows:

η=η₀e^{L(1-ε}^{ᵣ}⁾+η_{c}, for εᵣ≤ε_{r,c}, gas conditions (4a)

η=η_{c}(1+εᵣ−ε_{r,c}), for εᵣ>ε_{r,c}, liquid, dense, supercritical conditions (4b)

where η₀ is an initial gas-phase CO₂ kinematic viscosity at a low density available from literature, L is a regression coefficient of experimental data available from literature, η_{c} is the kinematic viscosity of CO₂ at critical conditions, also available from literature. Dynamic and kinematic viscosity are related as (see, also, Eq. 2):

$$η = \frac{μ}{ρ} . \qquad ( 5 )$$

The presence of impurities (such as N₂) in CO₂ rich streams has little effect on the permittivity-versus-density correlation (Eq. 3) and on the permittivity-versus-kinematic viscosity correlation (Eq. 4). Thus, if dielectric permittivity of a CO₂ rich stream can be ascertained, density and viscosity can be calculated and mass flow rate can be determined from pressure drop measured across a standard flow restriction, such as the Venturi flow restriction exemplified above.

Generally, microwave transmission and reflection properties of fluids can be used to determine bulk dielectric permittivity of a CO₂ rich stream. A microwave transmitter-receiver pair can be used to detect a cut-off frequency of microwaves propagating within a measurement pipe section (a circular waveguide) with a flowing CO₂ rich stream. The transmitter-receiver pair are installed such that the transmitter transmits microwaves into the flowing fluid, and the receiver can be disposed at a location opposite from the transmitter, such that the transmitter-receiver pair is oriented along a diameter of the flow pathway of the measurement pipe cross section. The transmitter and receiver can also be disposed in locations that are not directly opposite, one from the other. The transmitter may transmit microwaves at a suitable range of frequencies in the (circular waveguide) measurement pipe section, and attenuation of the signals is measured by the receiver at the corresponding range of frequencies. The peak frequency at which signal attenuation is minimized, sometimes referred to as a “cutoff frequency” (of a dominant propagation mode such as the TE₁₁ mode), can be related to bulk dielectric permittivity using one of the following equations:

$$\begin{matrix}{f}_{c} = {K}_{mode} \frac{{c}_{0}}{D \sqrt{{ε}_{r}}} ; & ( 6 a ) \\ {ε}_{r} = {( \frac{{f}_{c , 0}}{{f}_{c}} )}^{2} , & ( 6 b )\end{matrix}$$

where f_{c} is a dominant mode cutoff frequency, K_{mode} is the dominant mode coefficient (K_{mode}=0.586 for the TE₁₁ mode, K_{mode}=0.97 for the TE₂₁ mode,), f_{c,0} is the cutoff frequency measured at a standard condition where permittivity is equal to unity, such as in an empty pipe, c₀ is the vacuum speed of light, D is the flow pathway diameter of the measurement pipe section, and εᵣ is the bulk fluid dielectric permittivity of the fluid. Equations 6a and 6b can be used together, or only one of equations 6a and 6b can be used. Equation 6b can be used if cutoff frequency at the standard condition is known. Otherwise, equation 6a can be used to determine the bulk fluid dielectric permittivity. As an example, with a sufficiently high-frequency scan resolution, the measurement of cutoff frequency (and hence the permittivity and density determination) can be obtained with accuracy in the range of 489 MHz to 692 MHz for the TE₁₁ mode (with εᵣ from 2 to 1) for a 10-inch diameter pipe.

Two microwave transmitter-receiver pairs can be used for an accurate determination of fluid dielectric permittivity from a combined drift-immune transmission attenuation measurement. In a CO₂ rich flow measurement pipe section, two microwave transmitter-receiver pairs can be installed at two different pipe cross sections, or at the same pipe cross section, with the said cross section(s) being at the upstream, or at the restriction, or at the downstream of a flow restriction, such as at the inlet section, or the throat section, or the outlet section of a Venturi device. In one embodiment of two microwave transmitter-receiver pairs being installed at two different pipe cross sections, the two transmitter-receiver pairs can be installed along two intersecting diameters of the flow pathway or along two non-intersecting diameters of the flow pathway. The four transmission measurement data of the two pairs can be used to obtain one transmission measurement to improve accuracy and stability by compensating for instrument gain drift. A first transmitter-receiver pair T₁ and R₁ can be installed at a first diameter of the flow pathway and a second transmitter-receiver pair T₂ and R₂ can be installed at a second diameter of the flow pathway that does not intersect with the first diameter. At a suitably high transmitting frequency (that is below the cutoff frequency), the two transmitter-receiver pairs enable four measurements of attenuation at two substantially different transmitter-receiver (far and near) spacings, a T₁-R₁ measurement f₁₁ (directly across the flow pathway with a near-spacing), a T₁-R₂ measurement f₁₂ (across the flow pathway and axially displaced with a far-spacing), a T₂-R₂ measurement f₂₂ (directly across the flow pathway with substantially the same near-spacing), and a T₂-R₁ measurement f₂₁ (directly across the flow pathway and axially displaced with substantially the same far-spacing). A compensated differential measurement can be determined from the four measurements, as follows:

$${f}_{cdm} = \frac{1}{2} ( {f}_{11} - {f}_{12} + {f}_{22} - {f}_{21} ) . \qquad ( 7 )$$

Dielectric permittivity is quadratically correlated to the compensated differential measurement, as follows:

εᵣ=1+aΔf_{cdm}+bΔf_{cdm}², (8)

where Δf_{cdm}=f_{cdm}(εᵣ)−f_{cdm}(empty pipe), a and b can be determined by correlation of the modeling results from 3D electromagnetic simulations or from experiments. Note that a and b are dependent on the transmitting frequency, the transmitter-receiver antenna types (magnetic dipole or electric dipole), and the transmitter-receiver antenna spacings, and the pipe diameter.

Dielectric permittivity can also be determined using low-frequency capacitance sensors, as is known in the art. Such sensors can be used, optionally with electrical capacitance tomography techniques known in the art, to determine dielectric permittivity instead of, or in addition to, measurements using microwave sensors.

Research shows that the above relations are durable where some impurities are present in a carbon-captured CO₂ stream. The relations above have been shown to hold closely for pure CO₂ and pure N₂ over the pressure and temperature ranges normally encountered in a CCUS process. A post-combustion and pre-combustion captured CO₂ rich stream typically has at least 95 vol % CO₂, where N₂ and O₂ are present in a small quantity up to 1.3 vol % and where water is present in a quantity up to 600 ppmv. Where a continuous flow of a CO₂ rich stream contains, or is expected to contain, free water, the free water (having a high permittivity εᵣ=40 to 80, depending on salinity and temperature) can be detected using a microwave reflection sensor. The microwave reflection sensor is installed at an internal wall of the flow pathway to resolve a large dielectric permittivity of any liquid water along the wall. A probe of the microwave reflection sensor may be optionally configured to contact any liquid water flowing along the wall to provide near-wall permittivity and conductivity readings that can be used to detect the presence of free water that may cause flow-assurance issues (such as the risks of formation of CO₂ ice-like hydrates or the risks of carbonic-acid pipe corrosion), and to resolve water salinity (calculated from near-wall water-rich permittivity and conductivity readings). Dielectric permittivity of a CO₂ stream with dispersed water can be ascertained using a suitable dielectric mixing model, such as a simplified Ramu-Rao model, as follows:

$${ε}_{r} = {ε}_{CO 2} ( \frac{1 + 2 α}{1 - α} ) , \qquad ( 7 )$$

where α is the volumetric water holdup (e,g, up to 600 ppmv) that may be determined from the εᵣ measurement from the microwave reflection sensor, or from the microwave transmission cutoff-frequency or from the compensated differential attenuation, and ε_{CO2} is the dielectric permittivity of the non-water portion of the CO₂ stream that can then be used to calculate mass flow rate using the relations above. A microwave reflection sensor can be used with any combination of the other microwave sensors described above. The microwave reflection sensor may be located substantially in the same plane as one or more microwave transmitter-receiver pairs, or in a different plane.

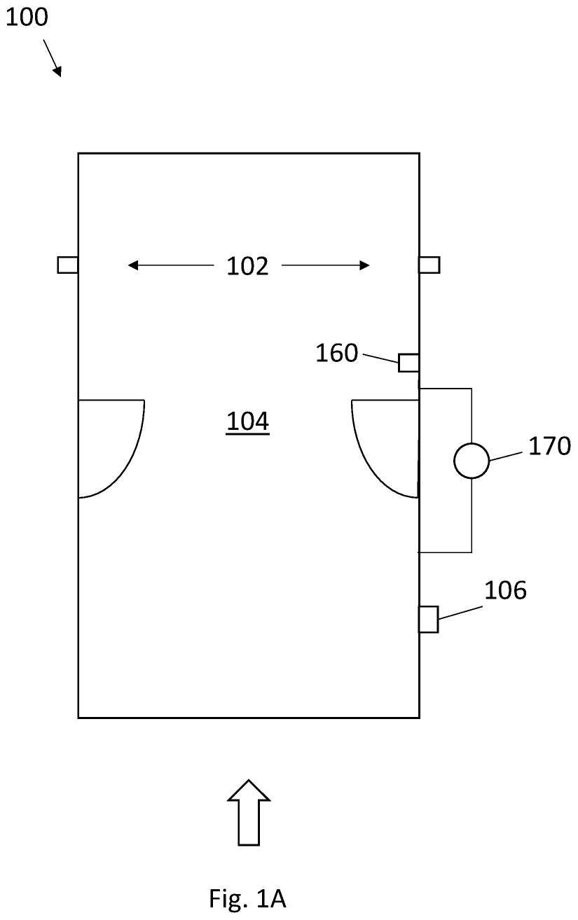

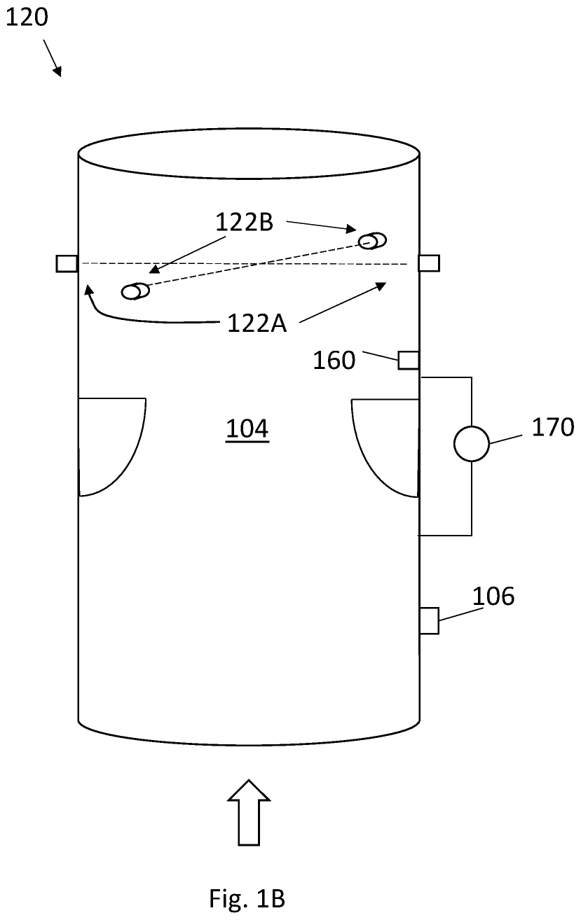

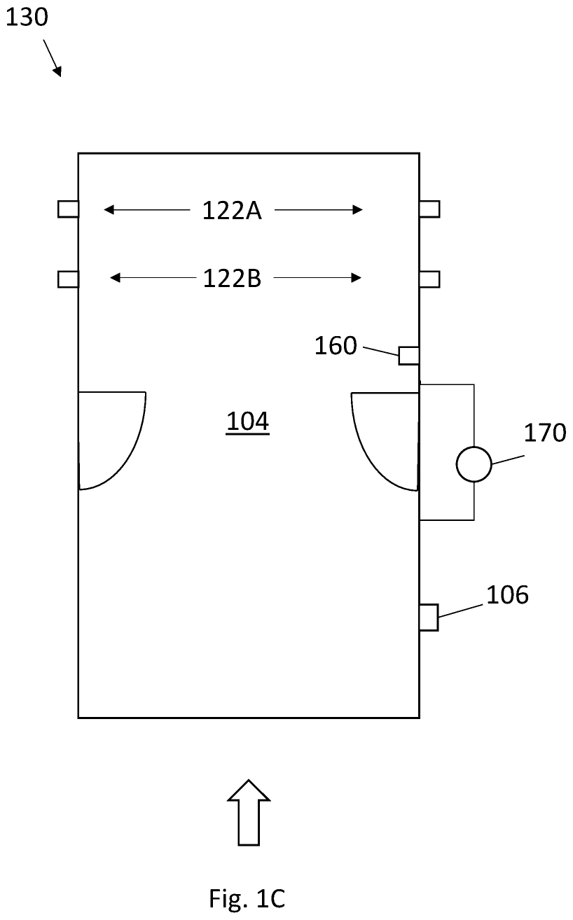

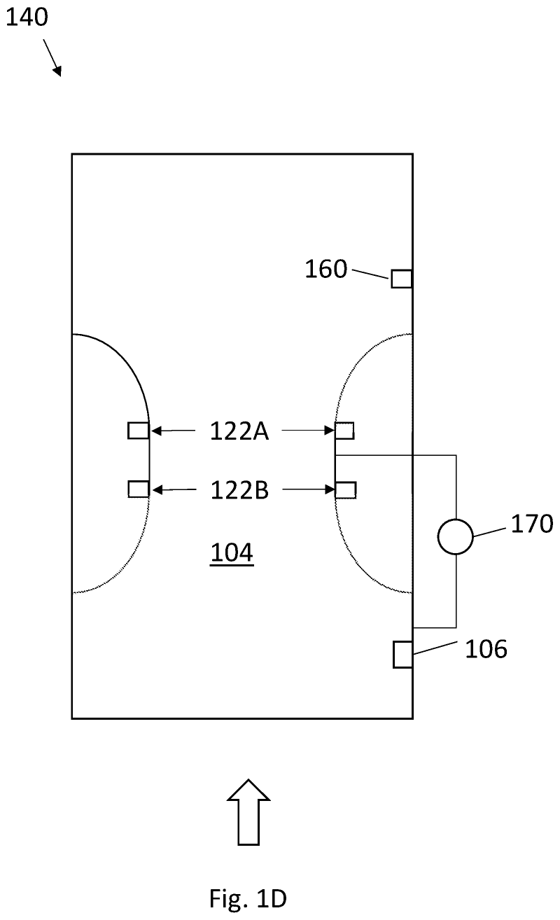

FIGS. 1A-1D are schematic views of flow measurement devices that can be used to practice the methods described herein to determine mass flow of a CO₂ rich stream. FIG. 1A shows a flow measurement device 100 that uses a single microwave transmitter-receiver pair 102. The microwave transmitter-receiver pair 102 is shown located at an outlet side of a flow restriction 104 of the flow measurement device. An optional microwave reflection sensor 106 is included in the flow measurement device 100. Here, the microwave reflection sensor 106 is located at an inlet side of the flow restriction 104. The flow restriction 104 may be a flow nozzle flow restriction or another flow restriction such as a Venturi-style or an orifice plate whose pressure drop properties are closely related to flow rate.

FIG. 1B shows a flow measurement device 120 that uses two pairs of microwave transmitter-receivers 122A and 122B. In this case, the pairs 122A and 122B are located along intersecting diameters of the flow measurement device 120. The view of FIG. 1B is slightly vertically angled to show the positional relationship of the two pairs 122A and 122B.

FIG. 1C shows a flow measurement device 130 that uses the two pairs of microwave transmitter-receivers 122A and 122B located along non-intersecting diameters of the flow measurement device 130. The flow measurement devices 120 and 130 use the same flow restriction as the flow measurement device 100, and both also have an optional microwave reflection sensor 106, as in the flow measurement device 100. As noted above, each of the flow measurement devices 100, 120, and 130 can use a Venturi-style flow restriction as illustrated in FIG. 1D where the two pairs of microwave transmitter-receivers 122A and 122B are located along non-intersecting diameters of the flow measurement device 140 at the restriction (throat section) of a Venturi-style device. Each of the flow measurement devices 100, 120, 130 and 140 has an optional temperature sensor 160 located at an outlet side of the flow restriction in each case. Each device 100, 120, 130 and 140 also has a differential pressure instrument 170 to measure the pressure and pressure drop across the flow restriction. A digital processing system can be configured to receive signals from the various sensors of the flow measurement devices 100, 120, 130 and 140 and to calculate mass flow rate of the CO₂ rich stream flowing therein using the relations described above.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A method, comprising:
measuring a dielectric permittivity of a CO₂ rich stream flowing in a flow pathway;
determining a density of the CO₂ rich stream from the measured dielectric permittivity;
determining a viscosity of the CO₂ rich stream from the measured dielectric permittivity;
measuring a pressure drop of the CO₂ rich stream flowing through a flow restriction; and
determining mass flow rate of the CO₂ rich stream using the measured pressure drop, the determined density, and the determined viscosity.

2. The method of claim 1, further comprising measuring a dielectric permittivity at an interior wall of the flow pathway, detecting presence and a salinity of a free water at the interior wall, resolving a volumetric fraction of the free water, and ascertaining a dielectric permittivity of the water-free CO₂ rich stream from the measured dielectric permittivity of the CO₂ rich stream and the free water volumetric fraction.

3. The method of claim 1, further comprising measuring a dielectric permittivity across the flow pathway, detecting a dispersed water volumetric fraction, and ascertaining a dielectric permittivity of the water-free CO₂ rich stream from the measured dielectric permittivity of the CO₂ rich stream and the dispersed water volumetric fraction.
